(19) United States
(12) Patent Application Publication
(10) Pub. No.: US 2016/0239652 A1
(43) Pub. Date: Aug. 18, 2016

(54) IDENTITY AUTHORIZATION AND AUTHENTICATION

(71) Applicants: THE REGENTS OF THE UNIVERSITY OF CALIFORNIA, Oakland, CA (US); NEEM SCIENTIFIC, INC., San Diego, CA (US)

(72) Inventors: Deli Wang, San Diego, CA (US); Siarhei Vishniakou, Oakland, CA (US); Hongtao Hou, San Diego, CA (US)

(21) Appl. No.: 15/031,511

(22) PCT Filed: Oct. 22, 2014
(86) PCT No.: PCT/US14/61846

§ 371 Date: Apr. 22, 2016

Related U.S. Application Data
(60) Provisional application No. 61/893,944, filed on Oct. 22, 2013.

(51) Int. Cl. G06F 21/32; G01L 5/00; G06F 21/62

(52) U.S. Cl. CPC G06F 21/32; G06F 21/62; G01L 5/0038

(57) ABSTRACT

A method of authorizing and/or authenticating a user includes: obtaining a first pressure profile of the user, the first pressure profile including at least a temporal pressure profile component; comparing at least one feature of the first pressure profile to at least one feature of a previously obtained pressure profile of the user, the previously obtained pressure profile including at least a temporal pressure profile component; and authorizing and/or authenticating the user if the at least one feature of the first pressure profile and the at least one feature of the previously obtained pressure profile match within a predefined threshold.

### BACKGROUND

In many applications, authentication of a user's identity is accomplished by matching a text password or a characteristic extracted therefrom (e.g., hash value) with a record associated with the user's identity. A text password is relatively easy to defeat, especially when people use the same password in different systems or use text strings closely associated with their lives (e.g., birthday, anniversary, address, etc.) Biometrics may be used in authentication of a user's identity but it often requires specialized hardware such as a fingerprint scanner or an iris scanner. Biometrics are not entirely impossible to forge. For example, a person's fingerprint may be lifted from an object the person touches and be used to defeat a fingerprint scanner.

### SUMMARY

In accordance with one aspect of the methods, techniques, devices and systems shown herein, a method of authorizing and/or authenticating a user includes: obtaining a first pressure profile of the user, the first pressure profile including at least a temporal pressure profile component; comparing at least one feature of the first pressure profile to at least one feature of a previously obtained pressure profile of the user, the previously obtained pressure profile including at least a temporal pressure profile component; and authorizing and/or authenticating the user if the at least one feature of the first pressure profile and the at least one feature of the previously obtained pressure profile match within a predefined threshold.

In accordance with another aspect of the methods, techniques, devices and systems shown herein, the first pressure profile and the previously obtained pressure profile may include a combination of a spatial pressure profile and the temporal pressure profile.

In accordance with yet another aspect of the methods, techniques, devices and systems shown herein, obtaining the first pressure profile may include measuring the pressure profile using an array of pressure sensors.

In accordance with another aspect of the methods, techniques, devices and systems shown herein, obtaining the first pressure profile may include measuring the first pressure profile using a single pressure sensor.

In accordance with another aspect of the methods, techniques, devices and systems shown herein, the feature may include a geometrical feature of the pressure profile.

In accordance with another aspect of the methods, techniques, devices and systems shown herein, the feature may be selected from a group consisting of pressure peak locations, pressure peak heights, changes in a pressure peak location, changes in a pressure peak height, relative locations between a plurality of pressure peaks, relative heights of a plurality of pressure peaks, saddle locations, integration of pressure over an area, and integration of pressure over a period of time.

In accordance with another aspect of the methods, techniques, devices and systems shown herein, obtaining the feature of the first pressure profile may be accomplished by determining a difference between a pressure peak location and a predefined location

In accordance with another aspect of the methods, techniques, devices and systems shown herein, obtaining the feature of the first pressure profile may be accomplished by determining a difference between a pressure peak height and a predefined value.

In accordance with another aspect of the methods, techniques, devices and systems shown herein, obtaining the feature of the first pressure profile may be accomplished by using a classification algorithm, a clustering algorithm, or a combination thereof.

In accordance with another aspect of the methods, techniques, devices and systems shown herein, when a difference between the feature of the first pressure profile and the feature of the previously obtained pressure profile is not within a predefined threshold or range, authorization and/or authentication of the user is denied.

In accordance with another aspect of the methods, techniques, devices and systems shown herein, the first pressure profile may be obtained with a pressure sensor that includes a substantially transparent ZnO film disposed on a substantially transparent substrate. The pressure sensor is configured to output an electrical signal based on a pressure applied thereon.

In accordance with another aspect of the methods, techniques, devices and systems shown herein pressure sensor may further include a transparent conductive layer and an electrically insulating layer sandwiched between the ZnO film and the substrate.

In accordance with another aspect of the methods, techniques, devices and systems shown herein, the first pressure profile may be obtained with an array that includes plurality of pressure sensors. Each of the pressure sensors may include a substantially transparent ZnO film disposed on a substantially transparent substrate. The pressure sensors are configured to output an electrical signal based on a pressure applied thereon.

In accordance with another aspect of the methods, techniques, devices and systems shown herein, the array may also include one or more temperature sensors.

In accordance with another aspect of the methods, techniques, devices and systems shown herein, the pressure sensors may be individually addressable.

In accordance with another aspect of the methods, techniques, devices and systems shown herein, a value representing a temperature of the user may be obtained while obtaining the pressure profile.

In accordance with another aspect of the methods, techniques, devices and systems shown herein, an electronic device is provided. The electronic device includes a processor, a display or touchpad and a computer-readable storage medium. The display or touchpad includes an array having a plurality of pressure sensors. The pressure sensors are configured to output an electrical signal to the processor based on a pressure applied thereon. The computer-readable storage medium has instructions recorded thereon. The instructions, when executed by the processor, implement a method comprising: obtaining a first pressure profile of a user, the first pressure profile including at least a temporal pressure profile component; comparing at least one feature of the first pressure profile to at least one feature of a previously obtained pressure profile of the user, the previously obtained pressure profile including at least a temporal pressure profile component; and authorizing and/or authenticating the user if the at least one feature of the first pressure profile and the at least one feature of the previously obtained pressure profile match within a predefined threshold.

### BRIEF DESCRIPTION OF THE DRAWINGS

FIG. 1 shows a flow chart schematically depicting a method according to an embodiment.

FIG. 2 shows, as contour diagrams, a pressure profile.

FIG. 3 shows exemplary features determined from the pressure profile in FIG. 2.

FIG. 4 shows another exemplary feature determined from the pressure profile in FIG. 2.

FIG. 5 schematically shows a cross section of a pressure sensor comprising a transparent ZnO thin film.

FIG. 6 shows an exemplary output as a function of pressure from the pressure sensor of FIG. 5.

FIG. 7 shows a temporal pressure profile obtained from an 8×8 array of the pressure sensors of FIG. 5.

FIG. 8 shows a spatial pressure profile obtained from an 8×8 array of the pressure sensors of FIG. 5.

FIG. 9 shows a known illustrative pressure profile of a user being compared to two measured pressure profiles.

FIG. 10 shows an exemplary cross section of an array of pressure sensors with temperature sensors.

FIG. 11 schematically shows a computer.

### DETAILED DESCRIPTION

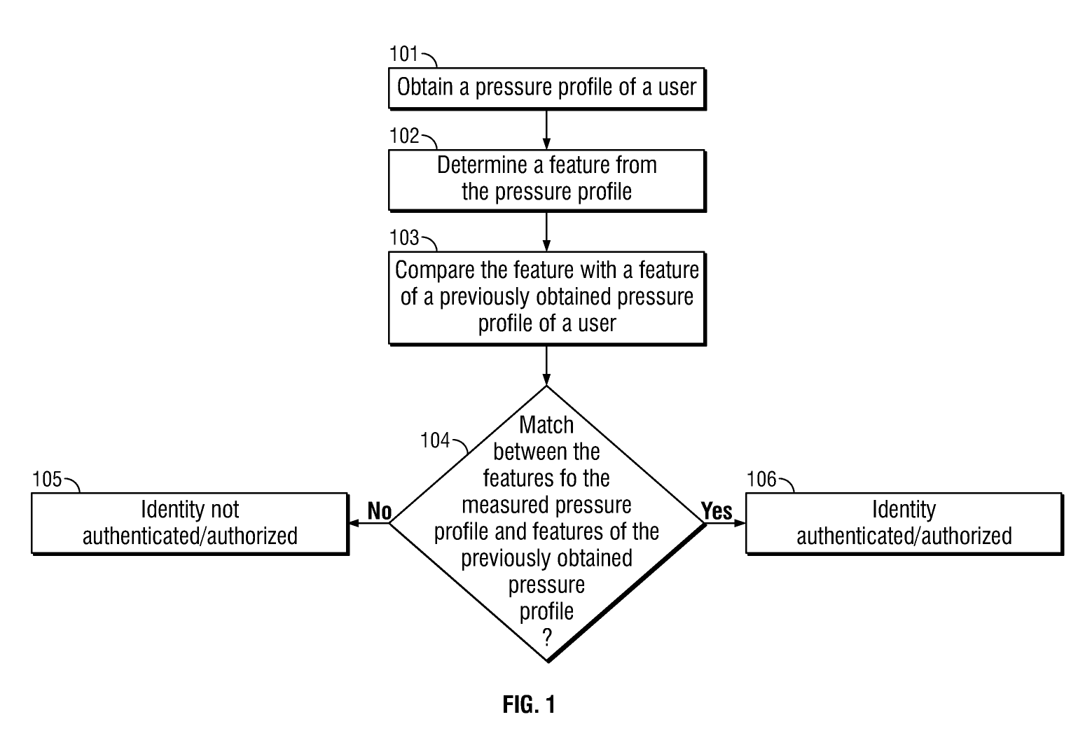

According to an embodiment, a method for authorizing and/or authenticating a user is schematically depicted in FIG. 1. The method includes measuring a pressure profile of the user in step 101; determining one or more features from the pressure profile in step 102; comparing the one or more features to one or more features of a previously obtained pressure profile of the user in step 103; if the one or more features match the one or more features of a previously obtained pressure profile of the user to within a predefined threshold in step 104, the user is authorized and/or authenticated in step 106; if the one or more features do not match the one or more features of the previously obtained pressure profile of the user to within the predefined threshold in step 104, the user is not authorized and/or authenticated in step 105.

The previously obtained pressure profile may be treated as a known pressure profile of the user. The previously obtained pressure profile may be stored in a database that includes previously obtained pressure profiles of other users.

In step 101, the pressure profile includes at least a temporal pressure profile component, which may be obtained using any suitable method. For example, the pressure profile may be obtained using a single pressure sensor or an array of pressure sensors. If an array of pressure sensors is employed, in some implementations the pressure profile may include both a spatial pressure profile component and a temporal pressure profile component..

As used herein, a spatial pressure profile includes a plurality of values representing pressure at a plurality of locations (e.g., on a two-dimensional surface, or in a three-dimensional space) at any given time. Likewise, a temporal pressure profile includes a plurality of values representing pressure at a plurality of times on a given pressure sensor that represents a single location, point or pixel.

In step 102, various features may be extracted or otherwise determined from a pressure profile. For example, the features may include a geometrical feature of the pressure profile. For example, the features may include pressure peak locations, pressure peak heights (i.e., pressure at these peaks), changes in a pressure peak location, changes in a pressure peak height, relative locations between a plurality of pressure peaks, relative heights of a plurality of pressure peaks, saddle locations, integration of pressure over an area, integration of pressure over a period of time, etc. Another feature that may be extracted from the pressure profile is the shape of the object (e.g., the user's finger(s) or palm) used to create the pressure profile.

The features that are extracted from the pressure profile essentially serve as a digital signature of the user and the process of comparing the features of the measured pressure profile to the stored pressure profile is essentially a process of verifying a digital signature.

In step 103, comparing the (at least one) feature of the pressure profile to the (at least one) feature of a previously obtained, stored pressure profile of the user may be accomplished using any suitable algorithm. For example, the profile may include several pressure peak locations, and the predefined profile may include several predefined pressure peaks at the predefined locations; the extraction and comparison of features may include determining sum of distances between the pressure peak locations to that of the predefined profile. For example, the profile may include several pressure peak heights at one or more locations, and the predefined profile may include several pressure values at one or more locations; the extraction and comparison of the feature may include determining the sum of differences between the pressure peak heights to that of the predefined pressure values.

As another example, the pressure profile may include multiple applications of the object creating the pressure profile at one or more locations with different times between the applications. Likewise, the predefined profile may include multiple applications of the object at one or more locations with different times between applications ; the extraction and comparison of the feature may include determining the differences in the time between pressure applications or between different locations and comparing those differences to those in the predefined pressure profiles. Typically, pressure applications of the object on the pressure sensors will be treated as belonging to the same pressure profile if they occur within a predefined time period of one another. Likewise, pressure applications of the object on the pressure sensors that are temporally separated from one another by a greater period of time will be treated as belonging to different pressure profiles.

In some implementations more sophisticated algorithms may be used to perform the feature extraction and comparison process. Examples of such algorithms include, but are not limited to, various classification algorithms (e.g., Linear discriminant analysis, Quadratic discriminant analysis, Maximum entropy classifier, Decision trees, decision lists, Kernel estimation and K-nearest-neighbor algorithms, Naive Bayes classifier, Neural networks, Perceptrons, Support vector machines, Gene expression programming) and clustering algorithms (e.g., Categorical mixture models, Deep learning methods, Hierarchical clustering (agglomerative or divisive), K-means clustering and Kernel principal component analysis (Kernel PCA)).

If the identity is authenticated in step 106, a service may be provided, a message may be displayed or transmitted, a program may be executed. For example, a computer file may be opened, a system may be logged in, data may be transmitted (e.g., emails, financial data).

If the identity is not authenticated in step 105, a service may be denied, a message may be displayed or transmitted, a program may not be executed.

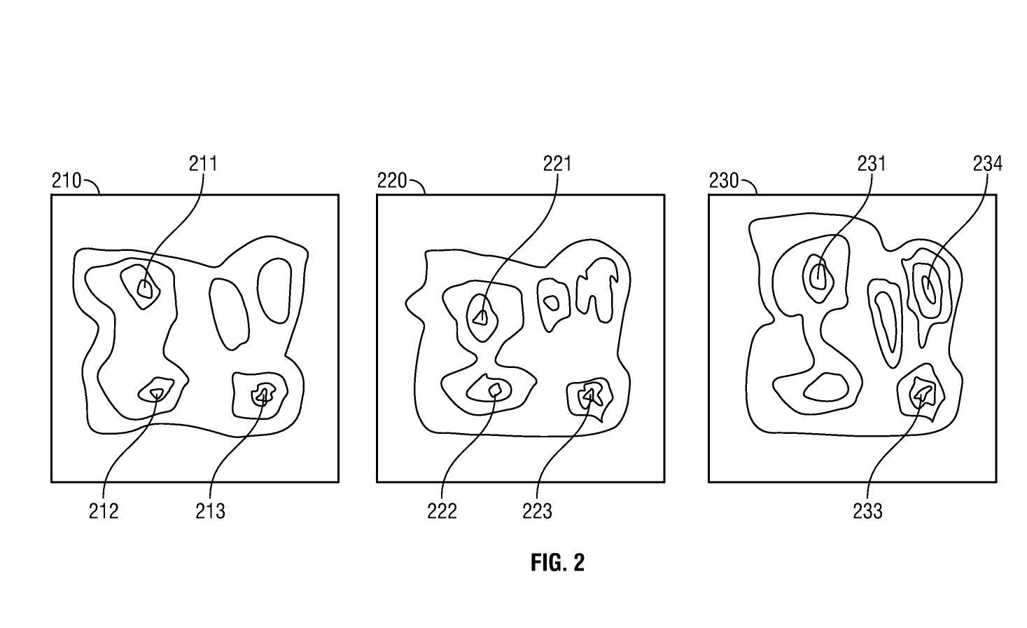

FIG. 2 shows, as contour diagrams, a pressure profile including values 210 representing pressure at a plurality of locations at a time T1, values 220 representing pressure at a plurality of locations at a time T2, and values 230 representing pressure at a plurality of locations at a time T3. In 210, three pressure peaks, 211, 212 and 213 may be identified. In 220, the three pressure peaks 211, 212 and 213 become (e.g., moved to) pressure peaks 221, 222 and 223, respectively. In 230, the three pressure peaks 221 and 223 become (e.g., moved to) pressure peaks 231 and 233, respectively; the pressure peak 222 disappears; and a new pressure peak 234 appears.

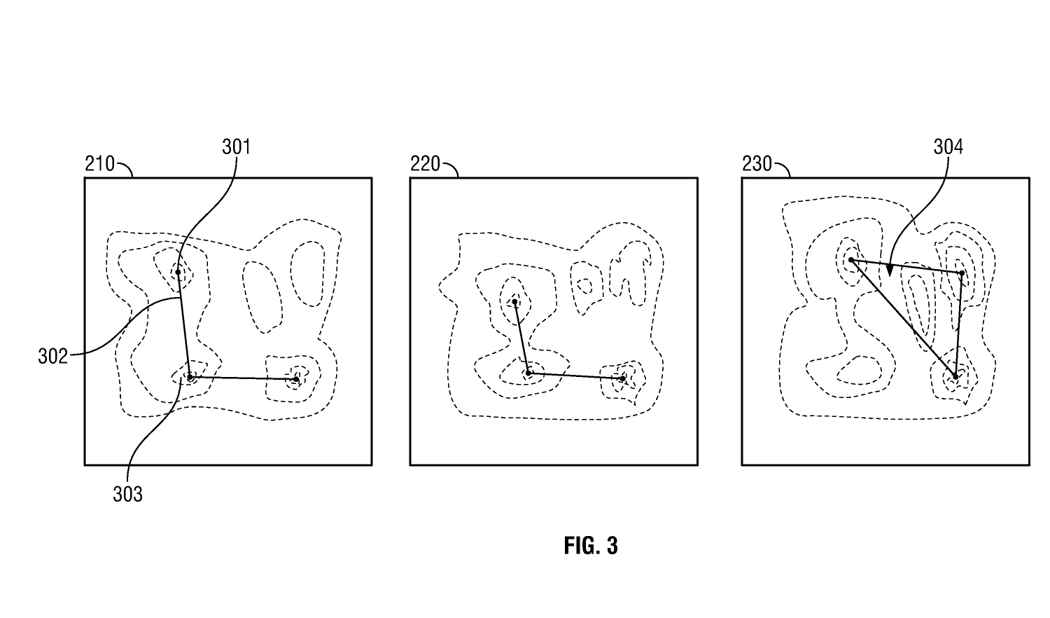

FIG. 3 shows exemplary features determined from the pressure profile in FIG. 2. The features may include location 301 of a pressure peak, distance 302 between two pressure peaks, an angle 303 between lines connecting neighboring pressure peaks, an area 304 enclosed by lines connecting neighboring pressure peaks.

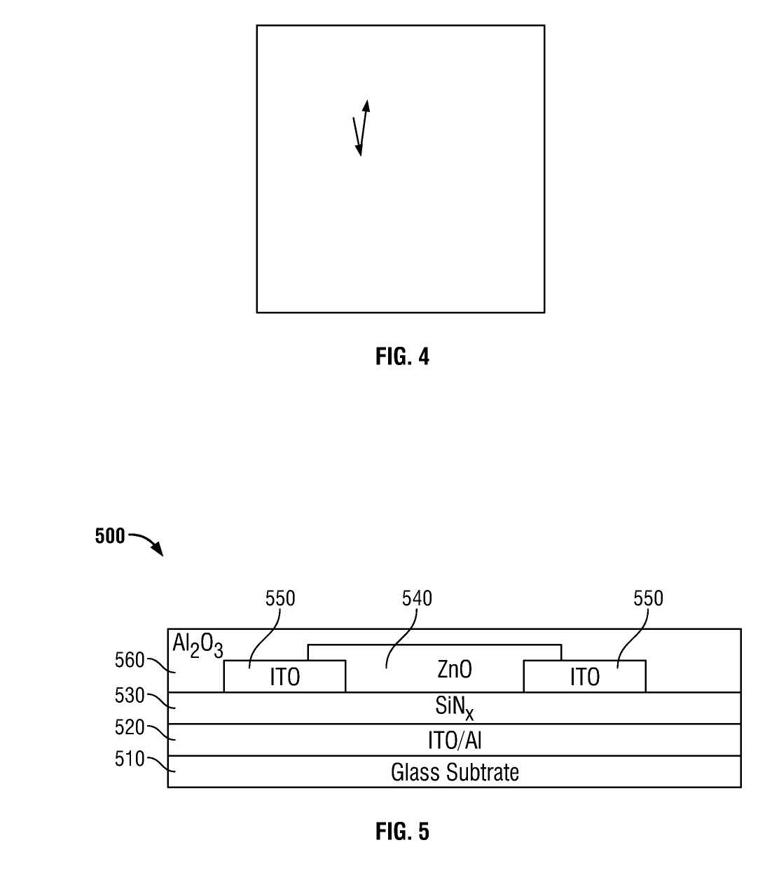

FIG. 4 shows another exemplary feature 410 determined from the pressure profile in FIG. 2, which is changes in a pressure peak location (peak 211 to peak 221 to peak 231, in this example) over time. According to an embodiment, an array of transistor-based pressure sensors may be used to obtain pressure profiles. The transistor-based pressure sensors preferable are configured to measure a plurality of magnitudes of pressure. The transistor-based pressure sensors preferable are configured to digitize the magnitudes of pressure. A memory may be connected to or integrated in the array. The memory may be configured to store one or more spatial pressure profiles and/or one or more temporal pressure profiles.

According to an embodiment, the pressure sensors may include any suitable elements responsible to pressure, such as a piezoelectric material (e.g., BaTiO₃, Pb(ZrₓTi₁₋ₓ)O₃, lead zirconate titanate (PZT), ZnO, CdS, GaN), polymers (e.g., Polyvinylidene fluoride (PVDF), nylon, and poly(γ-benzyl-1-glutamate) (PBLG)), or nanowires of these materials, piezoconductive polymer composite nanomaterials (carbon nanotubes, nanowires, quantum tunneling composites, grapheme and grapheme-like materials, 3D grapheme and grapheme-like materials, aerogel, sol-gel, etc.), piezoresistive materials (e.g., Si thin film, Si nanowire, carbon nanotube, graphene, etc.). The pressure sensors may also be electromagnetic sensors measuring the displacement of a diaphragm by means of changes in inductance or reluctance, Hall effect, or by Eddy current effect. The pressure sensors may also be optical sensors measuring the optical change (reflection, emission, absorption, fluorescence quenching, etc.) with applied pressure, for example, using Fiber Bragg gratings quantum dots emission. The pressure sensors may also be a micro-electrical-mechanical-system (MEMS) or a nano-electrical-mechanical-system (NEMS) device. The pressure sensors may also be capacitive sensors having a flexible dielectric layer (e.g., nano/micro pyramids and rods structures). One exemplary flexible dielectric layer is described in a publication titled “Highly sensitive flexible pressure sensors with microstructured rubber dielectric layers” by Mannsfeld, S. C. B. et al., Nature Mater. 9, 859-864 (2010), which is hereby incorporated by reference in its entirety.

The pressure sensors may also be active matrix thin-film transistor (TFT) pressure sensors. The TFT pressure sensors may include a semiconductor thin film (e.g., Si, Ge, SiGe, III-V semiconductors, II-VI semiconductors, metal oxides, polymers, etc.) prepared by a suitable technique (e.g., evaporation, CVD, solution deposition) or a thin film including nanostructures of semiconductors (e.g., quantum dots, nanotubes, nanowires, etc.).

The pressure sensors are preferably substantially transparent. For example, the pressure sensors preferable have a transmittance of 80% or more, 90% or more, or 95% or more. The pressure sensors are preferably positioned on a flexible substrate (e.g., with a stiffness of less than 10 N/mm, 5 N/mm, or 1 N/mm).

According to an embodiment, the pressure sensors comprise a transparent ZnO thin film. The ZnO thin film may function as conduction channel in a transistor and a pressure responsive material. An exemplary device including a ZnO thin film is described in a publication titled “Tactile Feedback Display with Spatial and Temporal Resolutions” by Siarhei Vishniakou, et al., Scientific Reports 3, Article number 2521 (2013), which is hereby incorporated by reference in its entirety.

FIG. 5 schematically shows a cross section of such a pressure sensor 599. The pressure sensor may be disposed on any suitable substrate (e.g., glass, plastic) 510. Preferably, the substrate is substantially transparent. A transparent conductive layer 520 such as indium tin oxide (ITO) or a thin layer of metal such as aluminum is disposed on the substrate. An electrically insulating layer (e.g., silicon nitride) 530 may be disposed on the substrate to electrically insulate the transparent conductive layer, and serve as the dielectric of a capacitor between the ZnO film and the transparent conductive layer. A layer of ZnO 540 is disposed on the electrically insulating layer and is connected to an electrode (e.g., ITO) 550. The ZnO layer preferably is encapsulated by a protective layer (e.g., aluminum oxide) 560.

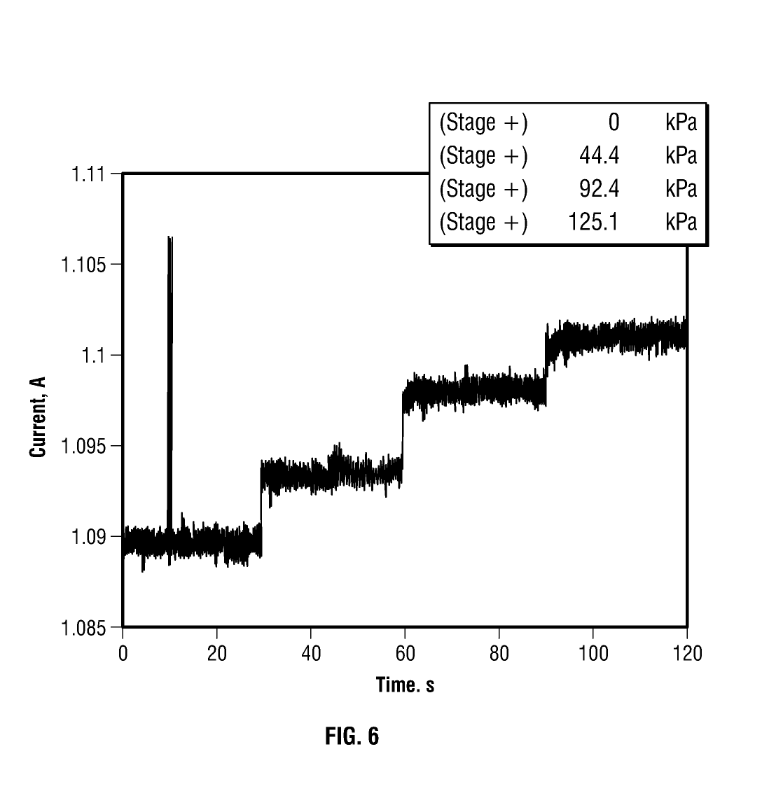

FIG. 6 shows an exemplary current output as a function of pressure from the pressure sensor of FIG. 5, which shows that the pressure sensor of FIG. 5 may detect multiple magnitudes of pressure.

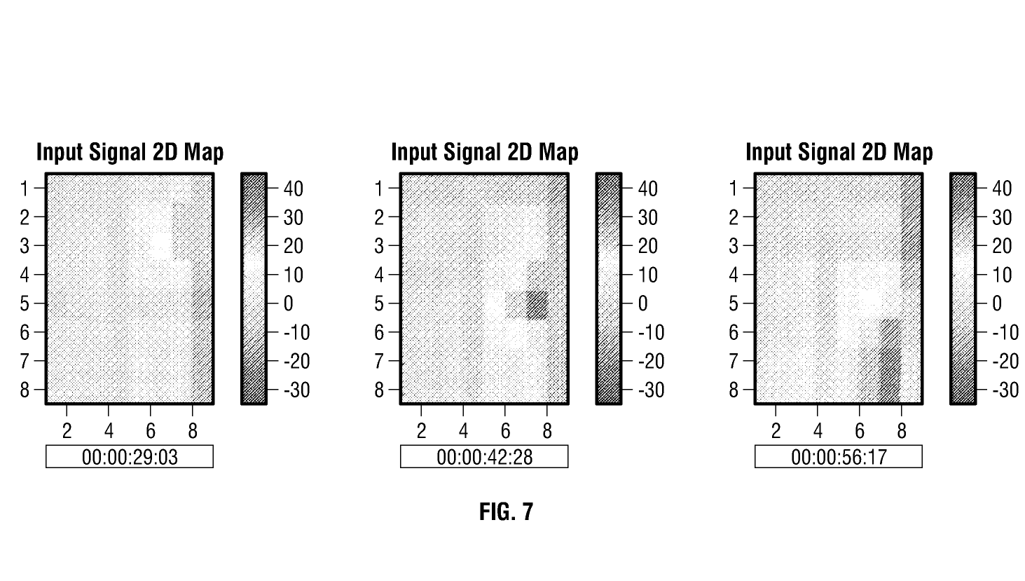

FIG. 7 shows a temporal pressure profile obtained at three different times from an 8x8 array of the pressure sensors of FIG. 5.

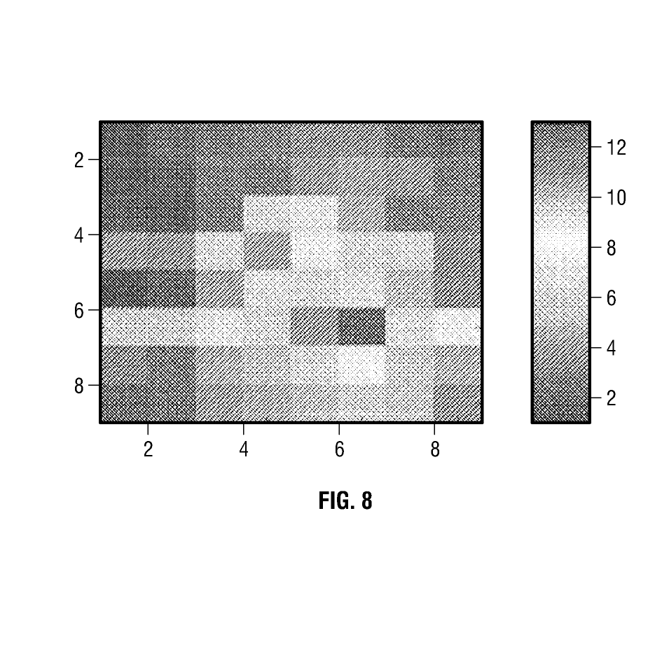

FIG. 8 shows a spatial pressure profile obtained from an 8x8 array of the pressure sensors of FIG. 5.

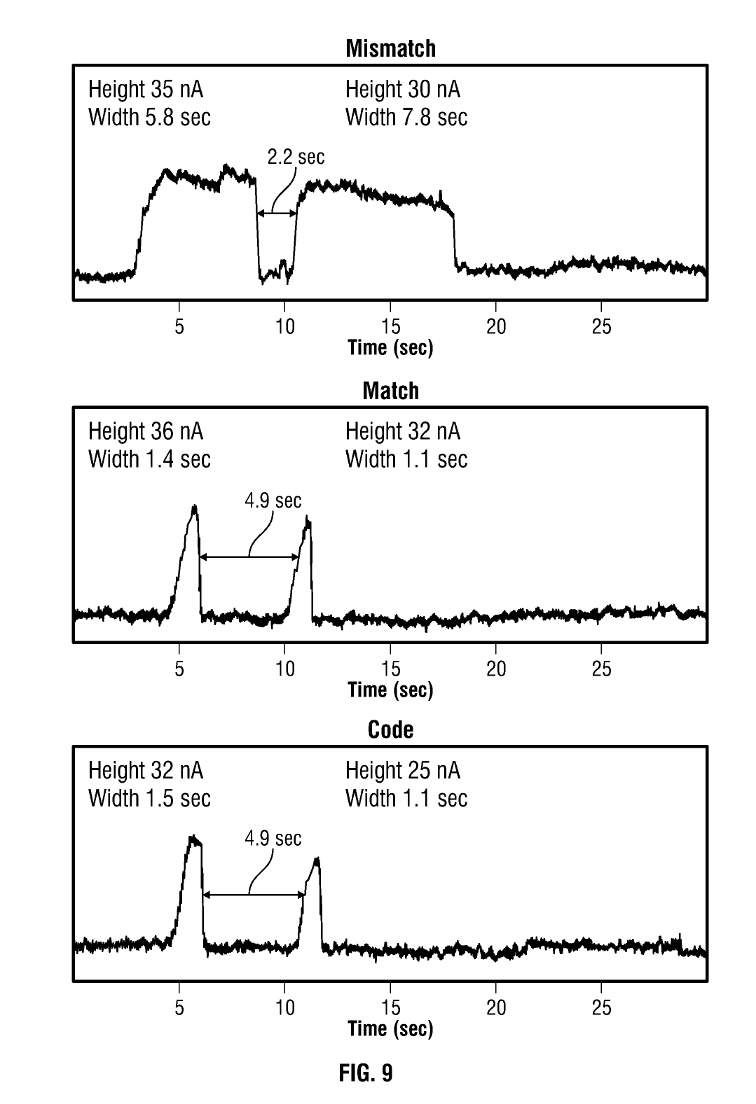

FIG. 9 shows an illustrative pressure profile having a temporal component. The bottom panel of FIG. 9 shows the profile of a user that is used as a known, previously obtained profile of the user. One pressure profile entered by the user in order to be authorized and/or authenticated is shown in the top panel. As evident from a comparison of the two pressure peaks that are selected as features for undergoing comparison, this pressure profile does not match the known profile, thus resulting in a mismatch that will lead to a denial of authorization and/or authentication. In contrast, the pressure profiled entered by the user in the middle panel matches the known profile, thus resulting in a positive match that will lead to authorization and/or authentication of the user.

According to an embodiment, an array of pressure sensors may further include one or more temperature sensors. The temperature sensors can obtain additional biometric information. This array may be used in a polygraph or a medical device, for example.

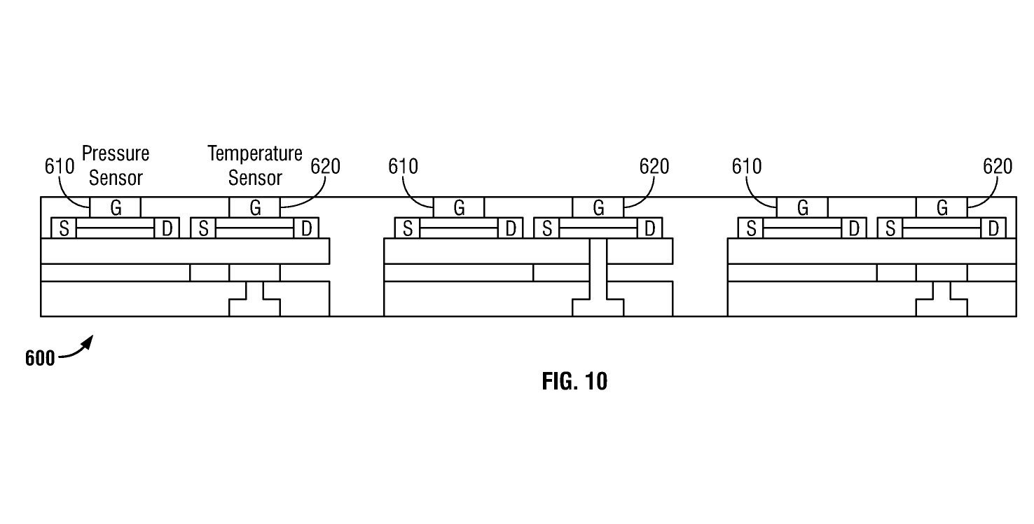

FIG. 10 shows an exemplary cross section of an array 600 of pressure sensors 610 with temperature sensors. The temperature sensors may be any suitable temperature sensor such as thermistors, resistance temperature detectors (RTDs), thermocouples, acoustic and optical sensors, and MOSFET and metal oxide chemo-FET, quartz crystal microbalance, micro-electromechanical systems (MEMS) sensors, nanowire FET, etc.

According to an embodiment, a portable electronic device (e.g., a phone, a tablet, a laptop computer) may include an array of pressure sensors as described above. The array of pressure sensors may be integrated in or disposed on a display, a touch pad, or a biometric sensor. According to an embodiment, the array of pressure sensors may be disposed on a surface of the portable electronic device, other than the display. For example, the array may be disposed on a surface opposite to a display and configured to be in contact of a user's hand when the portable electronic device is used.

According to an embodiment, an automatic teller machine may include an array of pressure sensors as described above.

According to an embodiment, a home security system may include an array of pressure sensors as described above. For example, the array may be disposed on a floor of a walkway or in front of a safe, which can measure weight, weight distribution of a person and use it to identify the person's identity.

According to an embodiment, the pressure profile may be combined with other security measures, such as text passwords, finger prints, iris patterns, and voice.

According to an embodiment, the array described herein may be used to capture a footprint or a palm print as a pressure profile. The footprint or palm print may be compiled into a database or compared against a database.

The pressure profile is not limited to one obtained from a person's body. For example, the pressure profile may be obtained from a textured surface of an inanimate object.

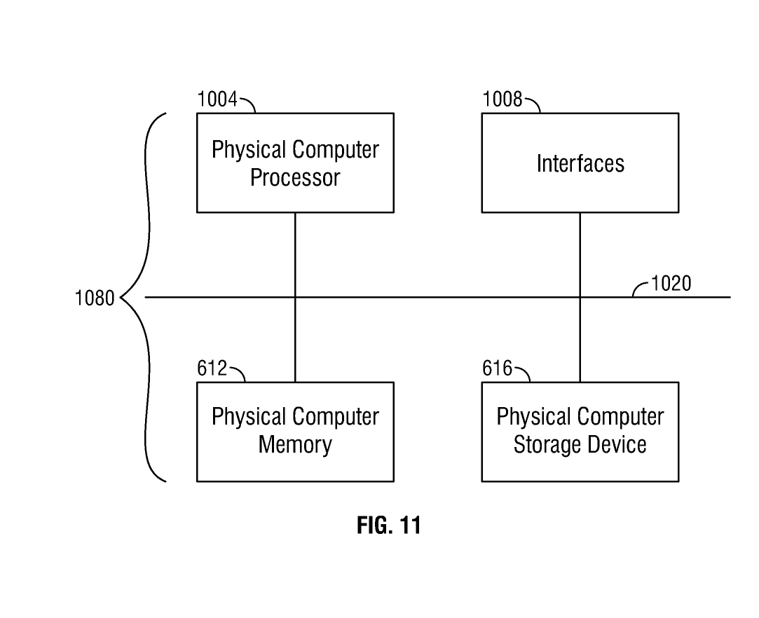

According to an embodiment, a computer 1080 shown in FIG. 11 may comprise a general purpose computer programmed with one or more software applications that enable the various features and functions of the embodiments disclosed herein, as described in greater detail below. In one exemplary implementation, computer 1080 may comprise a personal computer. Computer 1080 may also comprise a portable (e.g., laptop) computer, a cell phone, smart phone, PDA, pocket PC, or other device. The computer may also be implemented as part of a specialized device such as the aforementioned ATM, gaming device, home security system, medical device and so on.

Those having skill in the art will recognize that computer 1080 may comprise one or more processors 1004 (e.g., physical computer processors), one or more interfaces 1008 (to various peripheral devices or components), non-transitory memory 1012 (physical computer memory), one or more non-transitory storage devices 1016 (e.g., physical computer storage device), and/or other components coupled via a bus 1020. Memory 1012 may comprise random access memory (RAM), read only memory (ROM), or other memory. Memory 1012 may store computer-executable instructions to be executed by one or more processors 1004 as well as data which may be manipulated by the one or more processors 1004. Storage devices 1016 may comprise floppy disks, hard disks, optical disks, tapes, or other storage devices for storing computer-executable instructions and/or data. One or more software applications may be loaded into memory 1012 and run on an operating system of computer 1080. In some implementations, an Application Program Interface (API) may be provided to, for example, enable third-party developers to create complimentary applications, and/or to enable content exchange.

Computer 1080 may also employ one or more processors, digital signal processors (DSPs), application specific integrated circuits (ASICs), field programmable gate arrays (FPGAs), discrete logic, or any combinations thereof. When the various features and functions described above are implemented partially in software, a device may store instructions for the software in a suitable, non-transitory computer-readable storage medium and may execute the instructions in hardware using one or more processors to perform the techniques of this disclosure.

As mentioned above, aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Also, it is noted that some embodiments have been described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

In relation to the claims, it is intended that when words such as “a,” “an,” “at least one,” or “at least one portion” are used to preface a feature there is no intention to limit the claim to only one such feature unless specifically stated to the contrary in the claim.

The descriptions above are intended to be illustrative, not limiting. Thus, it will be apparent to one skilled in the art that modifications may be made without departing from the scope of the claims set out below.

We claim:

1. A method of authorizing and/or authenticating a user, comprising:
obtaining a first pressure profile of the user, the first pressure profile including at least a temporal pressure profile component;
comparing at least one feature of the first pressure profile to at least one feature of a previously obtained pressure profile of the user, the previously obtained pressure profile including at least a temporal pressure profile component; and
authorizing and/or authenticating the user if the at least one feature of the first pressure profile and the at least one feature of the previously obtained pressure profile match within a predefined threshold.

2. The method of claim 1 wherein the first pressure profile and the previously obtained pressure profile includes a combination of a spatial pressure profile and the temporal pressure profile.

3. The method of claim 1, wherein obtaining the first pressure profile comprises measuring the pressure profile using an array of pressure sensors.

4. The method of claim 1, wherein obtaining the first pressure profile comprises measuring the first pressure profile using a single pressure sensor.

5. The method of claim 1, wherein the feature includes a geometrical feature of the pressure profile.

6. The method of claim 1, wherein the feature is selected from a group consisting of pressure peak locations, pressure peak heights, changes in a pressure peak location, changes in a pressure peak height, relative locations between a plurality of pressure peaks, relative heights of a plurality of pressure peaks, saddle locations, integration of pressure over an area, and integration of pressure over a period of time.

7. The method of claim 1, further comprising obtaining the feature of the first pressure profile by determining a difference between a pressure peak location to a predefined location

8. The method of claim 1, further comprising obtaining the feature of the first pressure profile by determining a difference between a pressure peak height and a predefined value.

9. The method of claim 1, further comprising obtaining the feature of the first pressure profile by using a classification algorithm, a clustering algorithm, or a combination thereof.

10. The method of claim 1, further comprising, when a difference between the feature of the first pressure profile and the feature of the previously obtained pressure profile is not within a predefined threshold or range, denying authorization and/or authentication of the user.

11. The method of claim 1 further comprising obtaining the first pressure profile with a pressure sensor that includes a substantially transparent ZnO film disposed on a substantially transparent substrate, wherein the pressure sensor is configured to output an electrical signal based on a pressure applied thereon.

12. The method of claim 11 wherein the pressure sensor further comprises a transparent conductive layer and an electrically insulating layer sandwiched between the ZnO film and the substrate.

13. The method of claim 1 further comprising obtaining the first pressure profile with an array that includes plurality of pressure sensors, each of the pressure sensors including a substantially transparent ZnO film disposed on a substantially transparent substrate, wherein the pressure sensors are configured to output an electrical signal based on a pressure applied thereon.

14. The method of claim 13 wherein the array further comprises one or more temperature sensors.

15. The method of claim 13 wherein the pressure sensors are individually addressable.

16. The method of claim 1, further comprising obtaining a value representing a temperature of the user while obtaining the pressure profile.

17. An electronic device, comprising:
a processor;
a display or touchpad that includes an array having a plurality of pressure sensors, wherein the pressure sensors are configured to output an electrical signal to the processor based on a pressure applied thereon;
a computer-readable storage medium having instructions recorded thereon, the instructions when executed by the processor implementing a method comprising:
obtaining a first pressure profile of a user, the first pressure profile including at least a temporal pressure profile component;
comparing at least one feature of the first pressure profile to at least one feature of a previously obtained pressure profile of the user, the previously obtained pressure profile including at least a temporal pressure profile component; and
authorizing and/or authenticating the user if the at least one feature of the first pressure profile and the at least one feature of the previously obtained pressure profile match within a predefined threshold.

18. The electronic device of claim 17 wherein each of the pressure sensors includes a substantially transparent ZnO film disposed on a substantially transparent substrate.

19. The electronic device of claim 17, wherein the electronic device is selected from a group consisting of a cell phone, a smart phone, a tablet, a laptop computer, an automatic teller machine, a safe, a home/office/bank security system or entry, a gaming device, a PDA, a pocket PC, a medical device and a smart house detection/receiving system.
